(19) United States
(12) Patent Application Publication
(10) Pub. No.: US 2014/0267660 A1
(43) Pub. Date: Sep. 18, 2014

(54) ULTRASOUND DEVICE WITH VIDEO DISPLAY CAPABILITY AND ASSOCIATED DEVICES, SYSTEMS, AND METHODS

(71) Applicant: FUJIFILM Sonosite, Inc., Bothell, WA (US)

(72) Inventors: Nikolaos Pagoulatos, Kirkland, WA (US); Diku Pranav Mandavia, Los Angeles, CA (US); Leo Catallo, Mercer Island, WA (US); Roy Dean, Bellevue, WA (US); Brenten Scott Chauvin, Snohomish, WA (US); Richard Thomas Palm, Woodinville, WA (US)

(21) Appl. No.: 13/843,667

(22) Filed: Mar. 15, 2013

(51) Int. Cl. H04N 7/00

(52) U.S. Cl. CPC H04N 7/002
USPC 348/77

(57) ABSTRACT

A method of operating a portable ultrasound device to display digital video information from a video camera includes loading instructions into a memory of the device that configures processor electronics to process digital video signals. When a request for the video is received, the ultrasound device can ready itself to receive digital video information and display an image at a display of the ultrasound device based at least in part on the video information. In one embodiment, the video modality is enabled when the portable ultrasound device detects that the digital camera device has been connected to a port.

### TECHNICAL FIELD

The following disclosure relates generally to portable ultrasound devices and in particular to displaying images on ultrasound and video images on such devices.

### BACKGROUND

Anesthesiologists, emergency and critical care personnel, and operators in the field are some of the heaviest users of portable ultrasound devices. Because of their compact and lightweight size, portable devices can be deployed quickly. As technology advances, portable ultrasound devices are becoming more ubiquitous. However, despite their portable size, portable ultrasound devices can still have certain limitations.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a partially schematic, isometric diagram of a system including a portable ultrasound device and a video camera device configured in accordance with an embodiment of the present technology.

FIG. 2 is a block diagram illustrating ultrasound processor electronics configured in accordance with an embodiment of the present technology.

FIG. 3 is a flow diagram illustrating a routine for configuring a conventional ultrasound device to have a digital video display capability.

FIG. 4 is a flow diagram illustrating a routine for operating the video modality of the ultrasound device.

FIG. 5 is a flow diagram illustrating a routine for combining different modalities of imaging data into a common into a common electronic medical record.

### DETAILED DESCRIPTION

As discussed in greater detail below, the present technology disclosed herein relates to portable ultrasound devices and in particular to portable ultrasound devices that can display images based on digital video information (e.g., one or more frames of video) received from a video camera device. For example, the portable ultrasound device can display images based on USB (universal serial bus) data. Because the basic components and functions related to producing ultrasound imaging information and corresponding implementations are known, they have not been shown or described in detail here to avoid unnecessarily obscuring the described embodiments.

FIG. 1 is a block diagram of an ultrasound system 100 configured in accordance of an embodiment of the present technology. The ultrasound system 100 includes an ultrasound device 102 (e.g., a portable ultrasound device), a transducer assembly 103, and a video camera device 105 (“video device 105”).

The ultrasound device 102 includes a foldable housing 110 (e.g., a clamshell style housing), input devices 113, a display 114, and I/O ports 115a and 115b (referred to together as 115). The input devices 113a-113c (referred to together as 113) can include, for example, a touchpad 113a, controls 113b (e.g., buttons, switches, knobs, etc.), a keyboard 113c, as well as other suitable input devices (e.g., a touchscreen, a voice activated input, a scroll wheel, etc.). The display can include, for example, an LCD (liquid crystal display), LED (light emitting diode) or OLED (organic light emitting diode) display, a CRT (cathode ray tube) monitor as well as any other suitable display device known in the art. In the illustrated embodiment, the I/O ports 115 include a transducer port 115a and a universal serial bus (USB) port 115b. In other embodiments, however, the I/O ports 115 can include serial, parallel, or other suitable communication ports known in the art. In one particular embodiment, the ultrasound port 115a has a proprietary configuration unique to the transducer assembly 103.

The ultrasound device 102 further includes ultrasound electronics 112 (shown schematically) operably coupled to the input devices 113, the display 114, and the I/O ports 115. As described in greater detail below with reference to FIG. 2, the ultrasound electronics 112 include a programmable processor 240 and other electronic components configured to operate the transducer assembly 103 and the video device 105.

The transducer assembly 103 includes a housing 120, a transducer (e.g., a piezoelectric transducer; not visible), and transducer electronics 123 (shown schematically). The transducer electronics 123 can include, for example, transducer arrays, application specific integrated circuits (ASICs), field programmable arrays (FPGAs), and/or other suitable circuitry. Such circuitry is generally configured to operate the transducer and process acoustical signals to create ultrasound information 125 in the form of digital and/or analog signals. A first signal line 108a (shown schematically; e.g., an electrical cable) can provide the ultrasound information 125 to the ultrasound electronics 112 via the transducer port 115a.

The video device 105 includes a housing 130, an optical input 132 (e.g., a lens), and optical and video electronics 133 (shown schematically). The optical and video electronics 133 can include sensors (e.g., CCD sensors), optical detectors, and/or other suitable circuitry. In operation, the optical and video electronics 133 are configured to process incident light at the optical input 132 to produce digital video information 134 in the form of digital signals. A second electrical cable 108b (shown schematically; e.g., a USB cable) can provide the video information to the ultrasound electronics 112 via the USB port 115b.

The video device 105 can include any of a variety of devices that convert light (e.g., ultraviolet light (10 nm-380 nm) and visible light (380 nm-700 nm), IR light (700 nm-1 mm), etc.) into digital video information 134. For example, the video device 105 can include an internal camera (as shown) that is deployed within the vasculature, an organ cavity, the respiratory tract, the digestive tract, a body lumen, etc. In other embodiments, the video device 105 can include a handheld camera, such as a handheld probe. In one particular embodiment, the video device 105 can include a VividTrac endoscopic device from Vivid Medical, Inc., of 1023 Corporation Way Palo Alto, Calif. 94303.

In some embodiments, the USB port 115b provides a suitable connection for video devices that output video over a USB video device class (UVC) protocol. In several of these embodiments, however, the devices may be off-the-shelf devices that do not satisfy hospital-grade electrical requirements. Accordingly, in some embodiments, an isolator device 118 (e.g., a USB isolator) can be connected between the video device 105 and the USB port 115b to provide suitable electrical isolation.

Although not shown for purposes of clarity the ultrasound system 100 can include other components. For example, one or more batteries can power the portable ultrasound device 102. Similarly, one or more batteries can be configured to power the transducer assembly 103 and/or the video device 105. In some embodiments a wireless communication link could be used in lieu of one or both of the cables 108a and/or 108b. In other embodiments, the portable ultrasound device 102 can have a non-foldable housing and/or a touch screen display. In one embodiment, the portable ultrasound device 102 can include an M-TURBO Ultrasound Machine from SonoSite Fujifilm, Inc., of 21919 30th Dr. SE Bothell, Wash. 98021. In addition, some embodiments the ultrasound system 100 can include non-portable ultrasound devices.

FIG. 2 is a block diagram illustrating the ultrasound electronics 112 in more detail. The ultrasound electronics 112 include a programmable processor 240 and a memory 242, with the programmable processor 240 configured to execute instructions in the memory 242 to perform various processes, logic flows, and routines that can be embodied, for example, in the below described flow diagrams of FIGS. 3-5. As such, the illustrated embodiment represents the memory 242 as a component that can be distributed throughout the ultrasound electronics 112. For example, a portion of the memory 242 can represent a memory register at a display driver for storing, e.g., a color table and another portion of the memory 242 can represent a memory buffer for buffering, e.g., the digital video information 134. Other aspects of suitable processors and memory are described at the closing section of the Specification so as to not unnecessarily obscure the various embodiments of the present technology,

The programmable processor 240 is configured to operate ultrasound circuitry 244, a digital signal processor (DSP) 246, a display driver 248, and a communication device 250. The programmable processor 240 can direct the ultrasound circuitry 244 to produce ultrasound display data 252. For example, the ultrasound circuitry 244 can include, e.g., FPGAs, ASICS, and (other) DSPs, for processing the ultrasound information 125 into a displayable format. The programmable processor 240 can also direct the DSP 246 to produce video display data 253. The programmable processor 240 can direct the display driver 248 to produce an image signal 254 suitable for driving the display 114 (FIG. 1). In one embodiment, the programmable processor 240 can direct a multiplexer (MUX) 256 or other switching device to change the input of the display driver 248 to be the ultrasound display data 252, the video display data 253, or both the ultrasound display data 252 and the video display data 253. For example, in some embodiments, the image signal 254 can produce a split-screen image of both an ultrasound image and a video image.

The programmable processor 240 can also operate the communication device 250 (e.g., a network adaptor, a modem, a wireless transmitter, etc.) to communicate over a network. For example, as described in greater detail below, the programmable processor 240 can send/receive ultrasound images, video images, and/or patient medical record information to a server, such as a DICOM (digital imaging and communications in medicine) server.

In one aspect of this embodiment, the ultrasound device 102 (FIG. 1) is a conventional ultrasound device that was not originally manufactured or designed to process the digital video information 134. For example, conventional ultrasound devices are typically suited to display ultrasound information 125 (e.g., ultrasound information received in the form of analog signals). These devices can have antiquated electronics that have limited digital signal processing capabilities, or they can have application specific electronics, such as ASICS, that are customized for process ultrasound information but do not handle digital video information 134. In addition, conventional ultrasound devices typically only output image signals in greyscale and/or with limited amounts of color. While this type of output can be suitable for ultrasound, it is not desirable for the display of video and pictures.

FIG. 3 is a flow diagram illustrating a routine 360 for configuring a conventional ultrasound device to have a digital video display capability. In some embodiments, the routine 360 can be stored as a computer program that is loaded into the memory 242 of the conventional ultrasound device. For example, the program can be loaded into the memory 242 via the USB port 115b using a USB flash drive (e.g., a USB stick or thumb drive) or over a network via the communication device 250. In another embodiment, the computer program can be distributed, licensed, or sold in conjunction with the sale of a video device. In some embodiments, a CD-ROM, USB stick, or other suitable storage media containing the computer program can be within the same product packaging of the video device. In other embodiments, a company selling the video device can provide instructions to a user on how to download the computer program (e.g., after the user purchases a licensing key).

At block 361, the routine 360 modifies the graphics properties of the ultrasound electronics 112. In one embodiment, the routine 360 can change values in the memory 242 at the display driver 248 and/or the DSP 246. In some embodiments, the programmable processor 240 can reconfigure a frame buffer to load instructions relating to gamma correction, scaling, and/or color mapping. For example the image signal 254 of a conventional ultrasound device is grey scale, while video cameras by nature produce full color. In some instances, conventional ultrasound devices can render a limited number of colors for displaying Doppler color flow. However, this color is limited to a range of about 16 to 128 colors, which is not suitable for displaying a full range of colors required for video.

At block 362, the routine 360 can temporarily disable components of the ultrasound electronics 112. For example, the conventional ultrasound device may frequently use the communication device 250 to update patient medical information at a DICOM server. However, frequent updating can be a drain on processing resources. For example, this can saturate the digital video information and create stalls in the ultrasound electronics 112.

At block 363, the routine 360 can remap the input devices 113 with respect to the ultrasound electronics 112. For instance, a mechanical dial used to control aspects of the ultrasound modality (e.g., power, focus, etc.) can be remapped to control aspects of the video modality (e.g., frame rate, contrast, image size, etc.).

FIG. 4 is a flow diagram illustrating a routine 470 for operating the video modality of the ultrasound device 102. In one aspect of this embodiment, the routine 470 can be carried out after the ultrasound device 102 has been configured with the video capability. After a start block, the routine 470 receives a request to enable the video modality of the ultrasound device 102 (block 471). In one embodiment, the request is received while the ultrasound device 102 is in a standby mode. Another embodiment, the request is received while the ultrasound device is in the ultrasound modality.

In some embodiments, the user input is created by a user operating one or more of the input devices 113. For example, the user can toggle a button, a switch, a touchscreen icon, etc. In another embodiment, a user can immediately enable the video modality by connecting the video device 105 with the USB port 115b. For example, the programmable processor 240 can detect that a USB cable, for example, has been connected to the USB port 115b. In this regard, the user is not required operate the input devices 113.

At block 472, the routine 470 determines whether the ultrasound device 102 is in an appropriate state for switching to the video modality. For example, during critical procedures, such as needle-guided biopsies, the routine 470 can prevent a user from changing the modality. If the ultrasound device 102 is not in an appropriate state, the routine 470 can terminate. In some embodiments, routine 470 can also alert the user that the video modality is unavailable.

At block 473, the routine 470 readies the ultrasound device 102 for handling the video display data 253. As discussed above, this can include remapping one or more input devices 113, adjusting the graphics, and/or disabling components. In some embodiments, the routine 470 signals to the ultrasound electronics 112 (e.g., to the display driver 248) to route the video display data 253 to the display 114. In one embodiment, the routine 470 signals to the multiplexer 256 in the ultrasound electronics 112 to change input from a first signal path that outputs ultrasound display data to a second signal path that outputs the video display data 253. In another embodiment, the routine 470 signals to the ultrasound electronics 112 to display images corresponding to both video and ultrasound display data 253, 252 at separate portions of the display 114.

At block 474, the routine 470 creates the video display data 253 by processing video information received from the video device 105 (i.e., video data received at the USB port 115b). In one embodiment, the routine 470 signals to the ultrasound electronics 112 to process digital video information 134 received in the form of an mJPEG data stream. For example, the routine 470 can direct a USB driver (e.g., USB video class (UVC) driver) to decode the digital video information 134. In another embodiment, the programmable processor 240 directs the DSP 246 to process (or further process) the digital video information 134. For example, the DSP 246 can receive the digital video information 134 and output the video display data 253 in the form of YUV data.

In some embodiments, the routine 470 can also direct the ultrasound electronics 112 to communicate control information to the video device 105 (e.g., via the USB port 115b). For example, this information can indicate a particular frame size of the video, compression rate, etc. In one embodiment these parameters are default parameters that are automatically initialized by the ultrasound electronics 112. In another embodiment, these are set according to user preferences. In this regard, the ultrasound electronics 112 can be configured for bidirectional communication with the video device 105 in some embodiments.

At decision block 475, the routine 470 determines whether to capture the video display data 253 and/or digital video information 134 in a video clip or still image. If capture is not required, the routine 470 continues to block 476 to produce a video image. If, however, the video display data 253 and/or the video information 134 is to be captured, the routine 470 can initiate a routine 580 (FIG. 5) to being collected. As described in greater detail below, the captured video clips or still images can be formatted according to a DICOM protocol and stored at the DICOM server, for example. In many embodiments, the routine 470 and the routine 570 are carried out simultaneously or near simultaneously. In some embodiments, the digital video information 134 can be captured and then processed at a later stage for viewing. For example, an USB MSC (mass storage class) file can containing video data can be captured and later processed for displaying the video display data. In other embodiments other types of servers and protocols can be utilized, such as those that operate according to the HL7 protocol.

Referring again to FIG. 4 and at block 476, the routine 470 uses the video display data 253 to produce the image signal 254 (e.g., an RGB signal) for the display driver 248. In some embodiments, the routine 470 can also direct the ultrasound electronics 112 to display other information in combination with the video display data 253. For example, the routine 470 can display a graphical menu at the display 114.

At block 477, the routine 470 determines whether to continue outputting the image signal 254. If output is to continue, the routine 470 can return to block 471. However, if the video modality is to stop, the routine 470 can terminate. For example, the routine 470 may terminate when the user provides input requesting to proceed with ultrasound imaging. Alternatively, the routine 470 may terminate when the user provides input requesting to enter a standby mode.

In yet another aspect of the present technology, a method for operating an ultrasound device 102 includes changing between data collection modalities in a way that facilitates the creation of electronic medical records. In general, doctors, clinical staff, and others can use electronic medical records to review a patient's medical history, to bill an insurance provider, and/or to audit a medical procedure (e.g., after a medical malpractice claim). In many instances, electronic medical records are formatted into a DICOM protocol and stored at a remote server, such as DICOM server, H7 server, or other suitable server or protocol. Most ultrasound devices have a network adaptor or modem to relay ultrasound images directly to a DICOM server so that they can be stored in the patient's electronic medical record. For the most part, this storage requires only a limited amount of operator interaction with the ultrasound device. For example, the operator may be prompted to enter a patient's name, identify a target area on the image, etc. However, many medical imaging devices do not have this capability. For example, a conventional computer or similar equipment is usually required to operate a video-enabled endoscope, but the computer cannot readily provide the digital image data to a DICOM server. Rather, to store the video data, the practitioner must find the image file, access the electronic medal file (i.e., over a computer network) on the server, and append the image file with the electronic file.

FIG. 5 is a flow diagram illustrating a routine 580 for combining the video display data 253 and the ultrasound display data 252 into a common medical record. In one embodiment, for example, the common medical record is formatted according to part 10 of the DICOM protocol (Media Storage and File Format for Media Interchange). The routine 580 begins at block 581 after a start block. In one embodiment, the programmable processor 240 instantiates a new medical record at the start block. In another embodiment, the programmable processor 240 can open a medical record to append the video display data 253, the ultrasound display data 252 and/or the image signal 254 with other patient-specific information according to the DICOM protocol to instantiate the file.

At block 483, the routine 580 receives a display data capture file containing all or a portion of video display data 253 obtained during interaction with a patient or, in some embodiments a cohort of patients. In some embodiments, the routine 580 can determine if the medical record should additionally include ultrasound display data 252 as an ultrasound capture (block 485). If the medical record is complete without an ultrasound capture (e.g., does not contain ultrasound display data 252 or image signals 254 derived from ultrasound display data 252), the routine 580 can continue to block 587 to store the video capture in the file, such as the new medical record created at the start block and/or the medical record opened by the programmable processor 240 at block 581. However, if an ultrasound capture is available for including in the file, the routine 580 can proceed at block 589 to store the ultrasound capture in the file.

At decision block 591, the routine 580 determines whether more captures should be collected. Once the routine 580 determines that no additional data captures are to be stored, the file can be completed at block 593. If the routine 580 determines that more data captures (e.g., display data captures and/or ultrasound captures) should be stored in the file (e.g., medical record), the programmable processor 240 can await such additional captures at block 595 before completing the file at block 593 and/or the routine terminates.

In contrast to the many medical imaging devices described above, aspects of the routine 580, and as provided by the ultrasound device 102 and/or the ultrasound electronics 112, provide for delivery of digital image data (e.g., video display data 253) in addition to ultrasound data (ultrasound display data 252) directly to a DICOM server. One of ordinary skill in the art will recognize that the routine 580 could include additional steps and/or modify the order of steps such that, for example, ultrasound captures are first stored in the file and wherein the routine further queries the programmable processor 240 for digital display data capture files to further store in the file.

In another aspect of the present technology, a method for operating an ultrasound device includes changing between video and ultrasound modalities in a way that is convenient for operators. These operators can include, for example, operators in hospital-based environments (e.g., anesthesiology, critical care, emergency room, etc.) and operators in the field (e.g., emergency response, military, etc.). In these environments, response time is critical. Conventional digital video display devices, such as video camera devices connected to a computer display, however, often require a certain amount of initialization time for boot up, device configuration, etc. For example, a user typically has to click on an icon and wait for a splash screen to disappear before a webcam can be operated. In addition, equipment space and/or equipment weight is often an issue in these environments. The additional equipment needed to operate the camera device is often impracticable. Further, this additional equipment is not suitable because it is not medical grade certified. For example, conventional laptops, mobile devices, etc. are not medical grade certified.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A non-transitory computer readable media, including instructions that are executable by a programmable processor to perform a method of configuring an ultrasound device to display images based on digital video information received from a video camera device by at least one of:
loading instructions into memory for gamma correction, scaling, and/or color mapping of an ultrasound display configuration so that it operates in a video display configuration;
temporarily disabling a data connection with a server configured to track patient data; and
remapping one or more input devices for controlling ultrasound processing so that the input devices control image processing.

2. A method of operating a portable ultrasound device to display digital video information from a video camera, comprising:
loading instructions into a memory of the device that configures processor electronics to process digital video signals;
receiving a request to enable a video modality of the device;
in response to the request, determining that the ultrasound device is in an appropriate operational state to suspend ultrasound imaging;
readying the ultrasound device to receive digital video information; and
displaying an image on a display of the ultrasound device based at least in part on the video information.

3. The method of claim 2 wherein receiving the request to enable the video modality includes readying the ultrasound device in response to detecting that the digital camera device has been connected to a port.

4. The method of claim 2 wherein receiving the request to enable the video modality includes remapping at least one input devices at the ultrasound device.

5. The method of claim 2 wherein receiving the request to enable the video modality includes temporarily disabling a data connection with a server configured to track patient data.

6. The method of claim 2 wherein receiving the request to enable the video modality includes loading into memory for gamma correction, scaling, and/or color mapping of an ultrasound display.

7. A method for combining video display data and ultrasound display data collected at an ultrasound device into a common medical record, comprising:
receiving an ultrasound capture containing all or a portion of ultrasound display data captured at an ultrasound device;
after determining with the ultrasound device that a video capture is available for including in the record, appending the video capture to record; and
forwarding the record to a DICOM server.

8. A computer system configured to combining video display data and ultrasound display data, comprising:
a memory for storing a number of program instructions;
a processor configured to execute the instructions, in order to:
receiving a request to enable a video modality of the device;
in response to the request, determining that the ultrasound device is in an appropriate operational state to suspend ultrasound imaging;
readying the ultrasound device to receive digital video information; and
displaying an image on a display of the ultrasound device based at least in part on the video information.

9. The computer system of claim 8 wherein readying the ultrasound device comprises readying at least one of display driver circuitry, communication circuitry, display driver processing, and/or data processing.

10. The computer system of claim 8 wherein readying the ultrasound device further comprises switching a multiplexer of the display driver circuitry.
